(19) United States
(12) Patent Application Publication
(10) Pub. No.: US 2004/0032453 A1
(43) Pub. Date: Feb. 19, 2004

(54) Printing devices comprising a plurality of print heads

(76) Inventors: Michael Koblinger, Kolitzheim (DE); Karl Erich Albert Schaschek, Thungen (DE); Georg Schneider, Wurzburg (DE)

Correspondence Address: Douglas R Hanscom, Jones Tullar & Cooper, Eads Station, PO Box 2266, Arlington, VA, 22202, US

(21) Appl. No.: 10/415,654

(22) PCT Filed: Oct. 15, 2001
(86) PCT No.: PCT/DE01/03943

(30) Foreign Application Priority Data
Nov. 17, 2000 (DE) 10057061.5
Nov. 17, 2000 (DE) 10057062.3

(51) Int. Cl. B41J 2/145

(52) U.S. Cl. 347/40

(57) ABSTRACT

A printing device comprises a plurality of print heads with a large number of nozzle orifices. The print heads are arranged in a fixed manner during printing. The nozzle orifices are arranged over the entire maximum width of the material to be printed. The printing device facilitates the modification of a coating on a printing block.

The invention relates to printing devices having a plurality of print heads in accordance with the preamble of claims 1 or 2.

The printing device is with a plurality of print heads, each of which has a printing area whose extension in the printing direction fixes a line height, and whose extension transversely to the printing direction fixes a column width, wherein the print heads are arranged in several parallel rows spaced apart from each other, and the print heads of different rows are offset transversely to the printing direction in respect to each other.

The term “print direction” in this case means the movement direction of the material to be imprinted relative to the print heads. If printing plates mounted on rotating printing plate cylinders are provided as the material to be imprinted, the print direction extends vertically in respect to the axis of rotation of the printing plate cylinder and tangentially in relation to its surface.

Printing devices of this type are employed for placing images on printing plates, for example. A coating material, or as the reverse thereof a solvent for dissolving a coating, of the printing plate can be sprayed on the latter by means of the plurality of print heads.

In order to obtain a printed image of high quality, it is desirable to be able to apply the medium to be applied to the printing plates finely and evenly distributed to each area of the printing plate and without missing spots. For this purpose the print heads must be aligned in relation to each other sufficiently closely and with an accuracy of a few μm. On the other hand, the possible density of packing the print heads close to each other is limited, since they touch each other. It would therefore be desirable to make do with as few print heads as possible.

However, conventional print heads do not have any surfaces along which they could be aligned by means of suitable stops. In order to position such print heads in relation to a desired spot it is therefore necessary to compare the position of the print image with the desired position and to then displace the print heads accordingly.

U.S. Pat. No. 5,719,602 shows an ink jet print head with a multitude of nozzle groups. These nozzle groups are arranged offset in respect to each other.

DE 37 30 844 A1 discloses a matrix ink printer, wherein several print heads, each with several nozzle openings, are arranged offset in relation to each other. In this case the nozzle openings overlap in relation to the material to be imprinted.

GB 2 349 607 A shows a printing device with a plurality of print heads which are arranged offset in respect to each other. These print heads are arranged inclined in the radial direction in relation to a printing cylinder.

U.S. Pat. No. 4,864,328 shows an ink jet print head with several rows of nozzles, which are inclined in respect to the printing direction.

The object of the invention is based on providing printing devices with a plurality of print heads.

In accordance with the invention, this object is attained by means of the characteristics of claims 1 or 2.

The advantages which can be obtained by means of the invention lie in particular in that the dividing distance of the print heads in respectively one print head row corresponds to the column width times the number of rows, and the distance of the rows from each other corresponds to the line height times the number of rows increased by one. The column jumps in a print head row correspond to the number of print head rows, while the line jumps between adjoining print head rows are greater by one than the number of print head rows in the printing device. The print heads are arranged with such accuracy that no gaps and no overlaps between the print heads in areas where no printing, or double printing would occur, are provided. Accordingly, a high resolution with simultaneously a compact construction of the printing device can be achieved.

In an advantageous manner, the print heads of several rows are arranged in a common plane. Especially a particular print head from one row can lie on a common plane with a particular print head in every other row. The assembly of the individual print heads is made considerably easier. They can in particular be fastened on a level print head holder. Besides a compact arrangement, it is possible in this way to achieve a simple alignment capability of the print heads in relation to each other.

In further development of the invention, the individual print heads are arranged obliquely in respect to the print direction in order to achieve a higher resolution. Each printing head has a longitudinal direction which is determined by its print area, or by the line along which the nozzle openings are arranged. The print heads are arranged obliquely in respect to the print direction in such a way that the said longitudinal direction extends at an acute angle to the print direction. The angle can be matched to the existing circumstances, in particular to the shape of the print heads. In accordance with an embodiment of the invention, the angle can lie between 20° and 45°, in particular approximately 30°.

In further development of the invention, the print heads from the different rows are placed obliquely by the same angle. In particular, they can be arranged in such a way that the longitudinal directions of the print heads of different rows lie on a common plane. The common plane is inclined in relation to the print direction by the same angle by which the print heads are placed obliquely to the print direction.

Further advantages of the invention lie in particular in that, instead of displacing the print head in two axes for appropriately adjusting the print image sprayed by the print head on the material to be imprinted, the alignment of the print head, or of its print image, can be achieved more simply by a combination of a mechanical alignment in one axis and a time control of the shot of the print head. Thus, for aligning the print head transversely in respect to the printing direction, the print head is moved, while for aligning the print head in the printing direction, the time of the shot from the print head is changed. The term print direction in this case is meant to be the movement direction of the material to be imprinted relative to the print heads. If printing plates mounted on rotating printing plate cylinders are provided as the material to be imprinted, the print direction extends vertically in respect to the axis of rotation of the printing plate cylinder. The change in the time of the shot is usefully made as a function of the print speed, i.e. the running speed of the material to be imprinted. If the time of the shot from the print head is delayed, the material to be imprinted passes farther underneath the print head and vice versa, so that an adjustment of the printed image in the printing direction is achieved.

Several print heads of a multiple head printer can in particular be aligned with each other, wherein at least one of the print heads is displaced for the alignment of the print heads transversely to the printing direction, and/or for the alignment of the print heads in the printing direction, the time of the shot from at least one print head is controlled. The displacement, as well as the change of the time of the shot, can be performed individually for each print head, or possibly also for groups of print heads together.

The print heads are advantageously displaced on one axis. They are moved exclusively for achieving an alignment of the printed image transversely to the printing direction. The adjustment is considerably simplified by this. When performing a displacement in only one direction, it is not necessary to keep in mind that a displacement of the printed image in the other axis could possibly also occur. The latter is adjusted by the timed control of the time of the shot.

Preferably all print heads which are displaced are displaced in the same direction, i.e. along parallel axes. This simplifies the alignment of the print heads in relation to each other.

The print heads can be displaced transversely to the printing direction. In this way the alignment transversely to the printing direction is disengaged from the alignment in the print direction, so that the alignment process as a whole is simplified.

In accordance with another preferred embodiment of the invention, the print heads can each be pushed along an axis which forms an acute angle in respect to the printing direction. A resultant offset of the print heads in the printing direction can be compensated by a corresponding change of the time of the shot from the respective print head. In connection with obliquely placed print heads in particular, i.e. print heads, whose print nozzle row was placed obliquely in relation to the printing direction in order to permit a closer arrangement of the print heads in relation to each other, the displacement of the print heads can take place parallel with the oblique position, i.e. parallel in relation to the longitudinal orientation of the print heads defined by the row of printing nozzles. By means of such oblique placement in an arrangement of the print heads in several rows, it is possible for print heads of different rows to be fastened on a mutual, obliquely placed print head holder. A displacement can be performed in the longitudinal direction of the holder connecting the print heads.

In an advantageous manner an adaptation of the printing grid distance in the printing direction to the printing nozzle distance transversely to the printing direction can be performed by the time control of the individual nozzle shots as a function of the printing speed.

The alignment can be achieved in an advantageous manner by means of a print head positioning device for exclusively aligning the print head transversely to the printing direction, and of a time control device for controlling the time of the shot of the print head for aligning it in the printing direction.

The positioning device is preferably designed as a single-axis displacement device, by means of which the print head can be displaced along one axis. The displacement axis of the positioning device can be arranged transversely to the printing direction. In accordance with an advantageous embodiment of the invention, the print head positioning device has a displacement axis which forms an acute angle with the printing direction. The time control device is embodied in such a way that the resultant offset of the print head in the printing direction is compensated by a change of the time of the shot, at which the respective print head shoots the individual drops.

In a further development of the invention, the device has a plurality of print head positioning devices for aligning several print heads in relation to each other. The print heads are preferably adjustable individually and separately from each other. The control device can be designed in such a way that the shot time of the print heads can be set individually and/or in groups.

Advantages of the plurality of nozzles rest in particular in that the entire width of the material, in particular a printing plate, can be imprinted without it being necessary to move the print heads during the printing process.

An adjustment of the printing area transversely to the printing movement of the individual print heads is required only once. Setting of the printing resolution is performed by varying the angle of the nozzle rows in respect to the movement of the material to be printed.

A problem-free expansion is possible at any time because of the modular structure, which is theoretically unlimited. The compact structure of this printing device is possible by means of employing print heads without their own ink reservoir, or because of the special arrangement of the print head. Because of this arrangement of the print heads, the use of the circumferential angle around a cylinder is very little.

The use of standard ink jet print heads of narrow width, as well as the production in small series because of the use of level holders on which the print heads are fastened, have a cost-saving effect.

Exemplary embodiments of the invention are represented in the drawings and will be described in greater detail in what follows.

Shown are in:

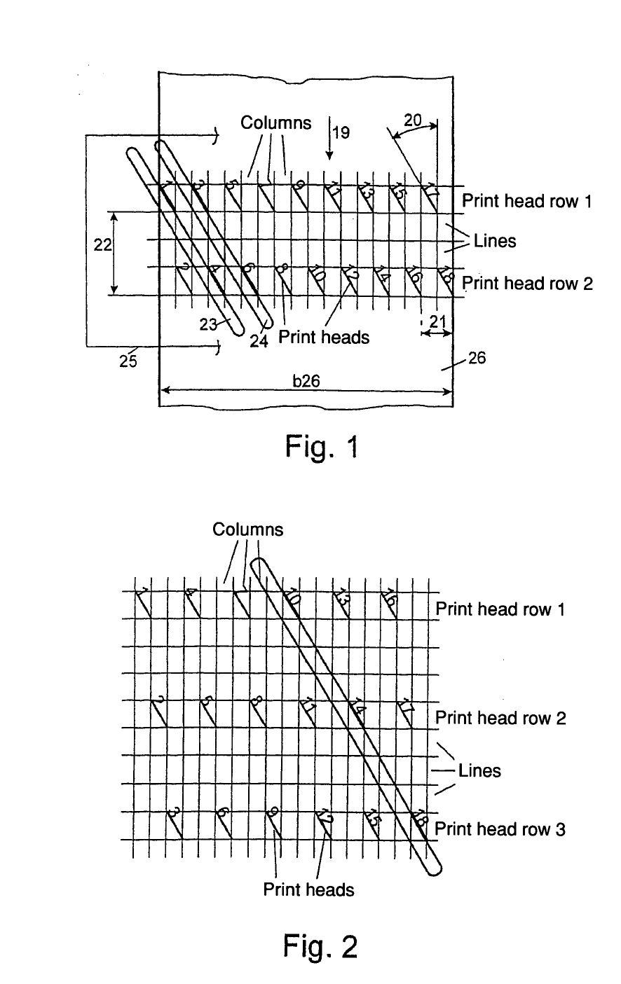

FIG. 1, a schematic representation of the arrangement of the print heads of a printing device in two rows in accordance with a preferred embodiment of the invention,

FIG. 2, a schematic representation of the arrangement of the print heads of a printing device in three rows in accordance with a preferred embodiment of the invention,

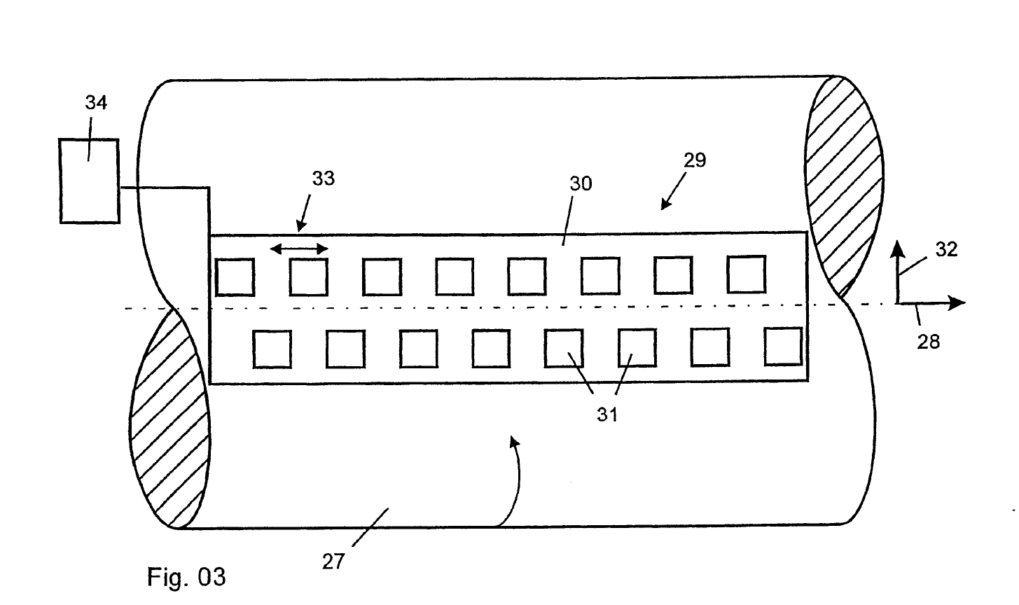

FIG. 3, a schematic representation of a multi-head ink jet printing system, having an arrangement for aligning the print heads of a printing system.

The printing device in accordance with FIG. 1 contains eighteen individual print heads 1 to 18, which are arranged in two rows of print heads. The rows of print heads extend spaced apart and parallel with each other, each vertically to the printing direction 19 indicated by the arrow.

All print heads 1 to 18 are placed obliquely by an angle of inclination 20 in respect to the printing direction 19 in order to achieve greater resolution. Because of the oblique placement of the print heads 1 to 18 it is possible to arrange the print heads 1 to 18 more closely in respect to each other, and the distance of the nozzle openings of the individual print heads 1 to 8 from each other transversely in relation to the printing direction can be reduced. As FIG. 1 shows, the angle of inclination 20 is defined on the one hand by the printing direction 19, and on the other hand by the longitudinal direction of each print head 1 to 18. The longitudinal direction of the print heads 1 to 18 is defined by the line along which the nozzle openings of one of the print heads 1 to 18 are arranged. Because of the oblique placement, the nozzle row of each print head 1 to 18 is provided with an extension in the printing direction 19, as well as an extension transversely to the printing direction 19. The extension transversely to the printing direction 19 determines the column width of a print head 1 to 18, while the extension of the row of nozzles in the printing direction 19 defines the line height of the corresponding print head 1 to 18.

The print heads 1 to 18 of each row of print heads are spaced apart from each other transversely to the printing direction 19. In this case the dividing distance 21 of the print heads 1 to 18 in one print head row corresponds to the column width times the number of rows, in the embodiment represented in FIG. 1 to the width of two columns:

Dividing distance 21=column width×number of print head rows

The rows of print heads are also spaced apart in the printing direction 19. The row distance 22 meets the following conditions:

Row distance 22=line height×(number of print head rows+1)

Thus, with two rows of print heads, as in the embodiment represented in accordance with FIG. 1, the row distance 22 corresponds to three times the line height which, as mentioned, is defined by the extension of the nozzle row of a print head 1 to 18 in the printing direction 19.

In accordance with the selected arrangement of the print heads 1 to 18, the print head 1, 2, 3, 4, 5, 6, 7, 8, 9, 10, 11, 12, 13, 14, 15, 16, 17, 18 which is respectively the next one transversely in respect to the printing direction 19, is always located in the next row and is not arranged in the same print head row. As the numbering of the print heads 1 to 18 shows, a first print head 1 is arranged in the first print head row, while the subsequent print head 2 is arranged in the second print head row.

With this arrangement of the print heads it is possible to advantageously provide that several print heads 1 to 18 are arranged on a common plane, so that they can be mounted on a level holder. As FIG. 1 shows, the print heads 1 and 4, the print heads 3 and 6, etc., are located on a common plane and are each mounted on a common print head holder 23, or 24.

This common plane of the nozzle openings of the print heads 1 and 4, 3 and 6, etc. is inclined at the angle of inclination 20 in respect to the printing direction 19 and extends vertically to the printing plane, i.e. to the material to be imprinted. In the case of a rotating material to be imprinted, for example a printing forme of a rotating cylinder of a printing press, the plane is inclined in respect to the axis of rotation of the cylinder and lies in the radial direction of the cylinder.

In principle it is possible to fasten, or arrange, the print heads 1 to 18 mounted on a print head holder 23, 24 on different sides of the latter. However, a simple and therefore preferred arrangement is provided in that the print heads 1 and 4 mounted on a print head holder 23 are arranged on the same side of the print head holder 23, as represented in FIG. 1.

The print head holders 23, 24 can be seated on a common support 25 (FIG. 1).

The number of print head rows is preferably selected in accordance with the space requirements. In accordance with FIG. 2, the print heads 1 to 18 can be arranged in three print head rows.

Otherwise the arrangement of the print heads 1 to 18 in FIG. 2 corresponds to the arrangement in accordance with FIG. 1. In particular, the column jumps between the print heads 1 to 18 of a print head row, as well as the line jumps, i.e. the distance between rows in the printing direction 19, correspond to the above mentioned relationship. In the same way, the oblique placement of the individual print heads 1 to 18 corresponds to the above mentioned connections. It is therefore possible to omit a further explanation of the arrangement in accordance with FIG. 2.

A printing plate cylinder in accordance with FIG. 3, on which the material 26 to be imprinted, for example a printing plate, in particular an offset printing plate 26 or a planographic printing plate 26, can be mounted, rotates in the usual manner around its longitudinal axis 28. A multi-head inkjet printing system 29 is provided for placing images on the printing plate 26. It has a printing beam 30, which extends parallel with the longitudinal axis 28 of the printing plate cylinder 26 opposite the circumferential side of the latter.

A plurality of print heads 31 is seated on the printing beam 30, which are embodied as ink jet heads and spray the printing liquid in drops on the printing plate 26. The print heads 31 are arranged in two rows, wherein the print heads 31 in the different rows are arranged offset transversely in relation to the printing direction 32. The printing direction 32 is determined by the rotatory movement of the printing plate cylinder and extends vertically in respect to the longitudinal axis 28.

The print heads 31 are displaceably seated on the print beam 30. The print heads 31 can be displaced individually in relation to the printing beam 30 along one axis by means of a print head positioning device 33, so that the position of the respective print head 31 is changed transversely to the printing direction 32, i.e. parallel with the longitudinal axis 28. The printed image can be set transversely to the printing direction by means of this.

A time control device 34, which controls the shot time of the individual print heads 31, or of the individual printing nozzles, is provided for the purpose of correcting, or aligning, the orientation of the print heads 31 in the printing direction 32.

In this way the problem of positioning, or aligning several print heads 31 in relation to each other in a plane is simplified by the separation of the two axes to be positioned. One axis is defined by the direction in which the material to be imprinted moves. Accordingly, this axis can be aligned by means of a skillful time control of the time of the shot of the individual printing nozzles. The other axis accordingly is located transversely in respect to the printing direction 32, in the example shown parallel with the longitudinal axis 28. It is therefore possible to mechanically align this axis 28 alone in a simpler way.

Although the exemplary embodiment describes the printing system by means of the placement of images on printing plates, the described alignment can also be used in other print head printing systems for different printing applications in which the position of the print heads 33 must be aligned.

The print heads 1 to 18, i.e. their nozzle openings, extend over the entire width b26 of a material 26 to be imprinted. During printing, the print heads 1 to 18 are stationary. They can only be moved for aligning the print heads 1 to 18 is relation to each other, or for increasing the resolution.

A variation of the printing resolution is possible by means of several image applications. Matching transversely to the printing direction is performed by the displacement of the printing unit between the printing process by a whole number fraction of an image point distance of the basic resolution, which lies approximately at 5μ and 50 μm, so that the printing grids are offset in respect to each other. Matching of the printing resolution in the direction of movement of the material to be printed is performed by an appropriate matching of the time control of the shot time.

Therefore the print heads are offset in the axial direction of the cylinder, in particular following a first revolution of the cylinder, preferably the entire printing beam 30 is laterally displaced.

The mentioned printing device preferably imprints material 26, which is arranged curved on a cylinder.

In this case the printing device has a means for changing the coating or for coating a printing forme 26, wherein the printing forme 26 is embodied as a planographic plate 26.

The printing plate 26 has an ink-absorbing layer, and an ink-repelling layer placed on it. Corresponding to the image to be printed, the printing device applies a developing fluid to the ink-repelling layer, by means of which the ink-repelling layer is changed in the charged areas.

For waterless offset printing the printing plate 26 is embodied with an ink-repelling layer of silicon.

Preferably, each print head has 64 to 256 nozzle openings, wherein the nozzle openings of a print head are arranged on a straight line.

### List of Reference Numerals

1 Print head

2 Print head

3 Print head

4 Print head

5 Print head

6 Print head

7 Print head

8 Print head

9 Print head

10 Print head

11 Print head

12 Print head

13 Print head

14 Print head

15 Print head

16 Print head

17 Print head

18 Print head

19 Printing direction

20 Angle of inclination (1 to 18)

21 Dividing distance (1 to 18)

22 Distance between rows

23 Print head holder

24 Print head holder

25 Support

26 Printing plate, material, material to be imprinted, planographic plate, printing forme

b26 Width of the material

27 Printing plate cylinder

28 Longitudinal axis

29 Multi-head inkjet printing system

30 Printing beam

31 Print head (1 to 18)

32 Printing direction

33 Print head positioning device

34 Time control device

1. A printing device having a plurality of print heads (1 to 18), each of which has a multitude of nozzle openings, characterized in that the print heads (1 to 18) are stationarily arranged during printing.

2. A printing device having a plurality of print heads (1 to 18), each of which has a multitude of nozzle openings, characterized in that the nozzle openings are arranged over the entire width (b26) of the material (26) maximally to be imprinted, and that the printing device applies a means for changing a coating of a printing forme (26).

3. The printing device in accordance with claim 1 or 2, characterized in that for mutual adjustment, the print heads (1 to 18) can be positioned in relation to each other at least partially transversely to the direction of a running material (26) to be imprinted.

4. The printing device in accordance with claim 1 or 2, characterized in that for increasing the resolution, the print heads (1 to 18) are arranged so that they can be positioned in at least two positions transversely to the direction of a running material (26) to be imprinted.

5. The printing device in accordance with claim 1, characterized in that the nozzle openings are arranged over the entire width (b26) of a material (26) maximally to be imprinted.

6. The printing device in accordance with claim 5, characterized in that the two positions are maximally spaced apart by 50 μm.

7. The printing device in accordance with claim 1, characterized in that the printing device applies a means for changing a coating or for coating a printing forme.

8. The printing device in accordance with claim 7, characterized in that the printing forme (26) is embodied as a planographic plate (26).

9. The printing device in accordance with claim 7, characterized in that printing plate (26) has an ink-absorbing layer, and an ink-repelling layer placed on it, and the printing device applies a developing fluid on the ink-repelling layer corresponding to the image to be printed, by means of which the ink-repelling layer is changed in the charged areas.

10. The printing device in accordance with claim 9, characterized in that for waterless offset printing the printing plate (26) is embodied with an ink-repelling layer of silicon.

11. The printing device in accordance with claim 1 or 2, characterized in that the printing device imprints material (26), which is arranged curved on a cylinder.

12. The printing device in accordance with claim 1 or 2, characterized in that each print head (1 to 18) has 64 to 256 nozzle openings.

13. The printing device in accordance with claim 12, characterized in that all nozzle openings of a print head (1 to 18) are arranged on a straight line.

14. The printing device in accordance with claim 1 or 2, characterized in that each of the print heads (1 to 18) has a printing area, whose extension in the printing direction (19) fixes a line height, and whose extension transversely to the printing direction (19) fixes a column width, wherein the print heads (1 to 18) are arranged in several parallel rows spaced apart from each other, and the print heads (1 to 18) of different rows are offset transversely to the printing direction in respect to each other, and the dividing distance (21) of the print heads (1 to 18) in respectively one print head row corresponds to the column width times the number of rows, and the distance of the rows from each other corresponds to the line height times the number of rows increased by one.

15. The printing device in accordance with claim 1 or 2, characterized in that the print heads (1 to 18) from different rows are arranged on a common plane, in particular that respectively one print head (1, 3, 5, 7, 9, 11, 13, 15, 17) of each row lies in a common plane with a respective print head from every other line (2, 4, 6, 8, 10, 12, 14, 16, 18).

16. The printing device in accordance with claim 1 or 2, characterized in that each print head (1 to 18) has a longitudinal direction determined by its printing area, i.e. by the position of the nozzle openings, and by means of this is arranged obliquely in respect to the printing direction (19).

17. The printing device in accordance with claim 1 or 2, characterized in that the print heads (1 to 18) are arranged in such a way that the longitudinal direction of print heads (1 to 18) from different rows lies in a common plane.

18. The printing device in accordance with claim 1 or 2, characterized in that print head holders (23, 24) are provided, on which print heads (1 to 18) from different rows are seated, in particular at least one print head (1, 2, 3, 4, 5, 6, 7, 8, 9, 10, 11, 12, 13, 14, 15, 16, 17, 18) from each row is seated, wherein preferably the print head holders (23, 24) are embodied level, in particular have a least a level surface.

19. The printing device in accordance with claim 1 or 2, characterized in that a time control device (34) for controlling the shot time of the print head (31) for its alignment in the printing direction (32), and a print head positioning device (33) for aligning at least one print head (31) relative to another print head (31) transversely to the printing direction (32), are arranged.

20. The printing device in accordance with claim 19, characterized in that the print head positioning device (33) is embodied as a single-axis displacement device.

21. The printing device in accordance with claims 20, characterized in that the print head positioning device (33) has a displacement axis transversely to the printing direction (32).

22. The printing device in accordance with claim 21, characterized in that the print head positioning device (33) has a displacement axis which extends at an acute angle to the printing direction (32), and the time control device (34) is embodied in such a way that a resultant offset of the print head (31) in the printing direction (32) is compensated by a change in the shot time of this print head (31).

23. The printing device in accordance with claim 22, characterized in that several print head positioning devices (33) are provided for aligning several print heads (31) in relation to each other, and the time control device (34) is embodied in such a way that, for aligning the print heads (31) in the printing direction (32), the shot time of the print heads (31) can be set individually and/or in groups.
